(19) United States
(12) Patent Application Publication
(10) Pub. No.: US 2025/0252600 A1
(43) Pub. Date: Aug. 7, 2025

(54) CALIBRATING A THREE-DIMENSIONAL SENSOR USING DETECTION WINDOWS

(71) Applicant: Magik Eye Inc., Stamford, CT (US)

(72) Inventor: Akiteru Kimura, Tokyo (JP)

(21) Appl. No.: 18/855,615

(22) PCT Filed: Apr. 10, 2023
(86) PCT No.: PCT/US23/18067

§ 371 Date: Oct. 9, 2024

Related U.S. Application Data
(60) Provisional application No. 63/329,879, filed on Apr. 11, 2022.
(60) Provisional application No. 63/329,884, filed on Apr. 11, 2022.
(60) Provisional application No. 63/329,885, filed on Apr. 12, 2022.

(51) Int. Cl. G06T 7/80; G06T 7/73; G06V 10/52; G06V 10/60; H04N 5/74

(52) U.S. Cl. CPC G06T 7/80; G06T 7/73; G06V 10/52; G06V 10/60; H04N 5/74; G06V 2201/07

(57) ABSTRACT

An example method includes controlling the projecting subsystem of a distance sensor to project a projection pattern onto a target object, controlling an imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, using a previously established detection window to locate the first point in the first image, calculating a spatial position of the first point on the target object, based on the second image, and storing the image position and the spatial position together as calibration data for the distance sensor.

### CROSS REFERENCE TO RELATED APPLICATIONS

This application is a national stage application of PCT/US2023/018067, filed on Apr. 10, 2023, which claims the priority of U.S. Provisional Patent Application Ser. No. 63/329,879, filed Apr. 11, 2022; U.S. Provisional Patent Application Ser. No. 63/329,884, filed Apr. 11, 2022; and U.S. Provisional Patent Application Ser. No. 63/329,885, filed Apr. 12, 2022, all of which are herein incorporated by reference in their entireties.

### BACKGROUND

U.S. patents applications Ser. Nos. 14/920,246, 15/149,323, and 15/149,429 describe various configurations of three-dimensional distance sensors. Such distance sensors may be useful in a variety of applications, including security, gaming, control of unmanned vehicles, and other applications.

The distance sensors described in these applications include light projecting subsystems (e.g., comprising lasers, diffractive optical elements, and/or other cooperating components) which project beams of light in a wavelength that is substantially invisible to the human eye (e.g., infrared) into a field of view. The beams of light spread out to create a projection pattern (of points, which may take the shape of dots, dashes, or other shapes) that can be detected by imaging subsystems (e.g., lenses, cameras, and/or other components) of the distance sensors. When a projection pattern projected by the projecting subsystem is incident upon an object in the field of view of the imaging subsystem, the distance from the distance sensor to the object can be calculated based on the appearance of the projection pattern (e.g., the positional relationships of the points) in one or more images of the field of view, which may be captured by the imaging subsystem. The shape and dimensions of the object can also be determined.

For instance, the appearance of the projection pattern may change with the distance to the object. As an example, if the projection pattern comprises a pattern of dots, the dots may appear smaller and closer to each other when the object is closer to the distance sensor, and may appear larger and further away from each other when the object is further away from the distance sensor.

### SUMMARY

An example method includes establishing a plurality of detection windows for a plurality of points of a projection pattern projected by a projecting subsystem of a distance sensor, based on a plurality of images captured by an imaging subsystem of the distance sensor, controlling the projecting subsystem to project the projection pattern onto a target object, controlling the imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, using a first detection window of the plurality of detection windows to locate the first point in the first image, calculating a spatial position of the first point on the target object, based on the second image, and storing the image position and the spatial position together as calibration data for the distance sensor.

In another example, a non-transitory machine-readable storage medium is encoded with instructions executable by a processor of a distance sensor, wherein, when executed, the instructions cause the processor to perform operations. The operations include establishing a plurality of detection windows for a plurality of points of a projection pattern projected by a projecting subsystem of a distance sensor, based on a plurality of images captured by an imaging subsystem of the distance sensor, controlling the projecting subsystem to project the projection pattern onto a target object, controlling the imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, using a first detection window of the plurality of detection windows to locate the first point in the first image, calculating a spatial position of the first point on the target object, based on the second image, and storing the image position and the spatial position together as calibration data for the distance sensor.

In another example, an apparatus includes a processing system including at least one processor and a non-transitory machine-readable storage medium encoded with instructions executable by the processing system. When executed, the instructions cause the processing system to perform operations. The operations include establishing a plurality of detection windows for a plurality of points of a projection pattern projected by a projecting subsystem of a distance sensor, based on a plurality of images captured by imaging subsystem of the distance sensor, controlling the projecting subsystem to project the projection pattern onto a target object, controlling the imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, using a first detection window of the plurality of detection windows to locate the first point in the first image, calculating a spatial position of the first point on the target object, based on the second image, and storing the image position and the spatial position together as calibration data for the distance sensor.

### BRIEF DESCRIPTION OF THE DRAWINGS

FIG. 1 is a block diagram illustrating a system for calibrating a three-dimensional sensor, according to examples of the present disclosure;

FIG. 2 illustrates one example of the projection pattern that may be projected onto the target surface of FIG. 1;

FIG. 3 is a flow diagram illustrating one example of a method for calibrating a three-dimensional sensor for distance measurement, according to the present disclosure;

FIG. 4 illustrates an example of three images of a projection pattern, captured at different distances from a target object, superimposed over each other to show how the image positions of the points of the projection pattern may move;

FIGS. 5A-5C illustrate a plurality of example light intensity distribution waveforms for the detection windows of the same point of a projection pattern at different distance sensor positions;

FIG. 5D illustrates an example light intensity distribution waveform for a detection window of a point of a projection pattern; and

FIG. 6 depicts a high-level block diagram of an example electronic device for calibrating a three-dimensional distance sensor.

### DETAILED DESCRIPTION

The present disclosure broadly describes an apparatus, method, and non-transitory computer-readable medium for calibrating a three-dimensional sensor using detection windows. As discussed above, a three-dimensional distance sensor such as the sensors described in U.S. patents applications Ser. Nos. 14/920,246, 15/149,323, and 15/149,429 determines the distance to an object (and, potentially, the shape and dimensions of the object) by projecting beams of light that spread out to create a projection pattern (e.g., of points, which may take the shape of dots, dashes, or other shapes) in a field of view that includes the object. The beams of light may be projected from one or more laser light sources which emit light of a wavelength that is substantially invisible to the human eye, but which is visible to an appropriate detector (e.g., of the distance sensor's imaging subsystem). The distance to the object may then be calculated based on the appearance of the projection pattern to the detector.

For instance, the spatial position (e.g., x, y, z coordinates) of a projected point on an object relative to the distance sensor may be calculated using the image position (e.g., u,v) of the corresponding point on the detector of the imaging subsystem's camera. In order to ensure the accuracy of this calculation, however, the distance must first be properly calibrated by measuring and storing a mapping between the spatial position of the projected point on the object and the image position of the corresponding point on the detector.

Conventional methods for calibrating a three-dimensional sensor such as the system described above may utilize two different calibration patterns. The three-dimensional sensor may capture a first plurality of images (e.g., at different tilt angles) of first calibration pattern, which may have a checkerboard pattern, using a camera of the three-dimensional sensor's imaging subsystem (i.e., a camera that is integrated or built into the three-dimensional sensor). The viewing angle and optical specifications of the camera may then be calculated from information extracted from the first plurality of images and used to calibrate the camera.

Once the camera is calibrated, the camera may subsequently capture a second plurality of images (e.g., at different distances from a target surface) of a projection pattern that is projected onto a second calibration pattern. In this case, the second calibration pattern may comprise a blank (e.g., white or grey) space surrounded by a patterned border, where the patterned border may comprise several rows of dots. The projection pattern may be projected onto the blank space of the second calibration pattern and may comprise a pattern of points as described above. Using the second plurality of images and the knowledge of the camera's viewing angle and optical specifications, the spatial positon (e.g., x, y, z coordinates) of each point on the second calibration pattern and the image position (e.g., u,v coordinates) of each point on the camera's detector may be calculated (or estimated through interpolation and extrapolation) and stored in association with each other.

This conventional calibration technique avoids the need for mechanical accuracy (except for in the calibration patterns) by performing an initial calibration of the camera with the first calibration pattern. Positional relationships can then be obtained through conventional image processing techniques. Moreover, since the origin of the coordinates of the three-dimensional (x, y, z) data corresponds to the principal point of the camera, it is relatively easy to reconstruct a three-dimensional image by superimposing the three-dimensional data on a two-dimensional image captured by the camera (e.g., an infrared image in the same wavelength range as the projecting subsystem of the three-dimensional sensor).

However, this conventional calibration technique tends to be processing-intensive. Moreover, it can be difficult to accurately detect the calibration targets, as well as the projection pattern, due to the camera focus shifting as the distance to the target surface changes; thus, additional processing may be required to correct for these focus shifts. Additionally, the optimal exposure conditions for capturing images of the calibration patterns and the projection pattern may be different, which may necessitate capturing images under a plurality of different conditions (e.g., camera settings and lighting) for both the calibration patterns and the projection pattern. It may also be necessary to change calibration patterns (e.g., use a pattern of a different size, pattern configuration, etc.) during the calibration process. In addition, since the origin of the coordinate system and spatial position (e.g., x, y, z, coordinates) of each artifact that are obtained through the conventional calibration technique are not associated with any physical coordinate reference, precision measurement, alignment with other equipment, and/or other processing may be needed to establish an association with a physical coordinate reference. Thus, many factors may add to the processing and manual labor needed to perform conventional calibration techniques.

Some techniques introduce a second camera, external to and separate from the three-dimensional sensor, which has a fixed position with respect to the target surface. In this arrangement, the only positional relationship that changes is the distance between the target surface and the three-dimensional sensor. However, the measurement accuracy of these techniques is still limited by differences between how a point's image position is calculated during calibration and how the point's image position is calculated during actual three-dimensional distance measurement.

Examples of the present disclosure provide a method for calibration of three-dimensional distance sensor using an external camera, separate from a distance sensor. During calibration, the distance sensor is used to establish a “detection window” for one or more points of a projection pattern. The detection window is established in part by detecting the positions of the points using a different technique than the technique used to detect the positions of the points during post-calibration distance measurement. For instance, the detection window for a given point may be established using an image processing technique, such as feature point detection, to detect the given point's position in an image. However, a different technique may be used to detect the same given point during post-calibration, where that different technique may utilize the detection window to limit an image area within which to search for the given point. Thus, a detection window limits the spatial area in which a corresponding point is expected to be observed by the distance sensor when the corresponding point is projected onto an object as part of a projection pattern. The detection window may be established by observing the image position of the same point, in a plurality of images captured at a plurality of different distances from a target object, and identifying the envelope or curve that continuously connects the image positions across the plurality of images. The detection window may be stored as calibration data, thereby ensuring the repeatability of the calibration and detection processes.

In further examples, calibration may include creating a plurality of wavelet templates based on the light intensity distribution waveform within the detection window. The wavelet templates may represent areas of peak light intensity within the waveforms, which may be indicative of the position of a point within the detection window. The shape of the wavelet for a given point may change with the distance from the target object; thus, a plurality of wavelet templates corresponding to different detection ranges with the light intensity distribution waveform and different distances from a target object may be created for each point and used later during distance detection.

Within the context of the present disclosure, the “image position” of a point of a projection pattern is understood to refer to the two-dimensional position of the point on an image sensor of a camera (e.g., a camera of a distance sensor's imaging subsystem). The “spatial position” of the same point is understood to refer to the position of the point on a target surface in a three-dimensional space. The point's image position may be expressed as a set of (u, v) coordinates, while the point's spatial position may be expressed as a set of (x, y, z) coordinates. Furthermore, an “external camera” is understood to refer to a camera that is not contained within the same housing as the imaging subsystem and projecting subsystem of the distance sensor. A processor of the distance sensor may still be able to communicate with the external camera to provide instructions for control of the external camera, however.

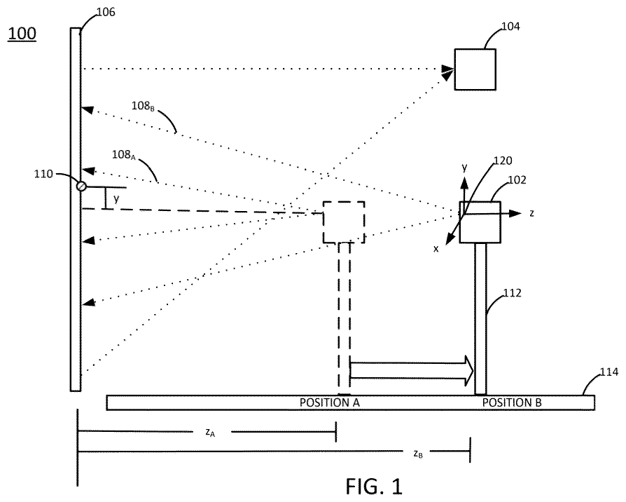

FIG. 1 is a block diagram illustrating a system 100 for calibrating a three-dimensional sensor, according to examples of the present disclosure. In one example, the system 100 generally comprises a distance sensor 102, an external camera 104, and a target surface 106.

The distance sensor 102 may be used to detect the distance to an object or surface, such as the target surface 106 or other objects. In one example, the distance sensor 102 shares many components of the distance sensors described in U.S. patent application Ser. Nos. 14/920,246, 15/149,323, and 15/149,429. For instance, in one example, the distance sensor 102 may comprise a light projecting subsystem, an imaging subsystem, and a processor, all contained within a common housing.

In one example, the light projecting subsystem of the distance sensor 102 may be arranged in a manner similar to any of the arrangements described in U.S. patent application Ser. No. 16/701,949. For instance, the light projecting subsystem may generally comprise a laser emitter, a lens, and a diffractive optical element (DOE). The light projecting subsystem may be arranged to emit a plurality of beams of light in a wavelength that is substantially invisible to the human eye (e.g., infrared light). In one example, when each beam of light is incident upon an object or surface such as the target surface 106, the beam may create a point of light (e.g., a dot, a dash, or the like) on the surface. Collectively, the points of light created by the plurality of beams of light form a projection pattern from which the distance to the surface can be calculated. For instance, the projection pattern may comprise a grid in which a plurality of points is arranged in a plurality of rows and columns.

The imaging subsystem of the distance sensor 102 may comprise a camera that is configured to capture images including the projection pattern. The camera may include an image sensor comprising a plurality of photodetectors (or pixels) that are sensitive to different wavelengths of light, such as red, green, blue, and infrared. For instance, the photodetectors may comprise complementary metal-oxide-semiconductor (CMOS) photodetectors.

The processor of the distance sensor 102 may control operation of the projecting subsystem and imaging subsystem. The processor may also communicate (e.g., via a wired and/or wireless communication interface) with systems and devices external to the distance sensor 102, such as the external camera 104. In further examples, the processor may also process images captured by the imaging subsystem in order to calculate the distance to an object or surface on which the projection pattern is projected. For instance, the distance may be calculated in accordance with the methods described in U.S. patent application Ser. Nos. 14/920,246, 15/149,323, and 15/149,429.

In one example, the distance sensor 102 may be mounted to a support 112. The support 112 may support the distance sensor 102 in such a way that the x and y coordinates of the distance sensor 102 in a three-dimensional space are fixed. However, in one example, the support 112 may be movable in one direction (e.g., the z direction in the three-dimensional space). For instance, the support 112 may be coupled to a track 114 that allows the z coordinate of the support 112, and, consequently, the z coordinate of the distance sensor 102, to be varied.

The external camera 104 comprises a camera that is separate from the distance sensor 102. The external camera 104 is “external” in the sense that the external camera 104 is not contained within the housing of the distance sensor 102 (unlike the camera of the distance sensor's imaging subsystem). For instance, the external camera 104 may comprise a separate RGB, infrared, or other type of camera that is mounted in a fixed position within the system 100.

The target surface 106 may comprise a flat screen or other solid surfaces. The target surface 106 may be of a solid, uniform color, such as white (e.g., may be blank). The target surface 106 may comprise an inflexible surface or a flexible surface. In one example, the target surface 106 has a uniform reflectance.

In one example, distance sensor 102, external camera 104, and target surface 106 cooperate to calibrate the distance sensor 102 for use in distance detecting. In one example, the projection subsystem of the distance sensor 102 may project a projection pattern onto the target surface 106. The projection pattern may comprise a plurality of points of light. The points of light may be arranged in a rectangular grid (e.g., comprising a plurality of rows and columns).

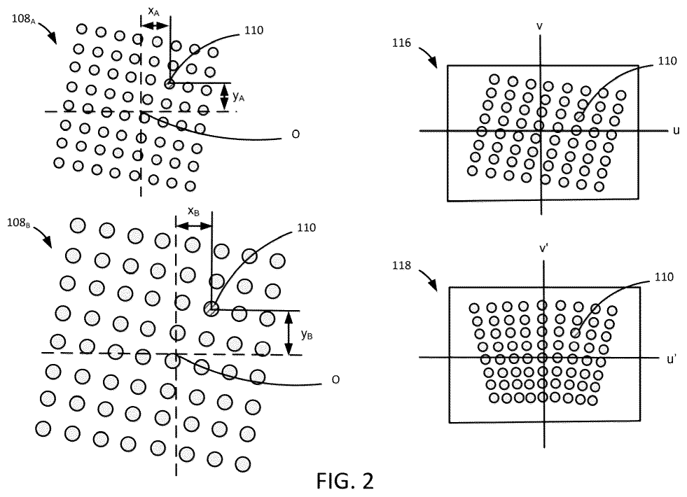

The imaging subsystem of the distance sensor 102 may capture an image of the projection pattern on the target surface 106 at multiple different distances (e.g., distances in the z direction between the distance sensor 102 and the target surface 106). The processor of the distance sensor may detect the positions of points of the projection pattern in the images, using a feature detection technique (or other image processing techniques). The processor of the distance sensor may then calculate, for each image at each distance, an image position of each point of the projection pattern on the image sensor of the imaging subsystem's camera. FIG. 2 illustrates an example image 118 of a projection pattern on the image sensor of the imaging subsystem's camera. The image position of an example point 110 is shown as (u′, v′). A curve that continuously connects the image position of the example point 110 across all of the images may be used to establish a detection window for the example point 110. The detection window may be used to detect the example point 110 later in the calibration process (as described below) and may also be used to detect the example point during post-calibration distance measurement.

Once detection windows have been established for the points of the projection pattern, the distance sensor 102 may be positioned at a first position, such as Position A, along the track 114. Position A in this case may have three-dimensional coordinates of (x, y, z_{A}). The distance sensor 102 may project a projection pattern (denoted in FIG. 1 as 108_{A} to indicate the appearance of the projection pattern when projected from Position A) onto the target surface 106 from Position A. Both the distance sensor 102, and the external camera 104 (whose position relative to the target surface 106 is fixed) may then capture images of the projection pattern 108_{A} on the target surface 106. FIG. 2, for instance, illustrates one example of the projection pattern 108_{A} that may be projected onto the target surface 106 of FIG. 1.

Both the distance sensor 102 and the external camera 104 may capture images of the projection pattern 108_{A}. In one example, the distance sensor 102 and the external camera 104 capture the respective images simultaneously (i.e., at the same instant in time). In another example, the distance sensor 102 and the external camera 104 may not necessarily capture the respective images simultaneously, but may capture the respective images while the projection pattern 108_{A} is projected from the same position of the distance sensor 102 (e.g., from Position A). The images captured by the distance sensor 102 and the external camera 104 will vary due to the different positions and settings of the distance sensor 102 and the external camera 104.

For each dot of the projection pattern 108_{A}, the distance sensor may compute a correlation between an image position (e.g., u,v coordinates) of the dot on image sensor of the imaging subsystem and a spatial position (e.g., x, y, z coordinates) of the dot on the target surface 106 (as detected from an image captured by the external camera 104). FIG. 2, for instance, shows an example image 116 of the projection pattern 108_{A} captured by the distance sensor 102. The image position (u, v) may be calculated by first using the detection window of the example point 110 (established as discussed above) to detect the example point 110 in an image captured by the imaging subsystem. The image position (u, v) may then be calculated for the example point 110.

Taking the example point 110 of the projection pattern 108_{A} as an example, the spatial position of the dot 110 as calculated from an image captured by the external camera 104 from Position A may be (x_{A}, y_{A}, z_{A}) (computed from an origin point O of the projection pattern 108_{A}). The correlation between the image position on the image sensor of the distance sensor's imaging subsystem and spatial position as calculated from the images captured by the external camera 104 from Position A may be stored in a memory of the distance sensor 102 (and/or in an external memory) as calibration data.

Then, the distance sensor 102 may be positioned at a second position, such as Position B, along the track 114. Position B in this case may have three-dimensional coordinates of (x, y, z_{B}). In other words, the only difference between Position A and Position B is the distance from the target surface 106 (as indicated by the z coordinate). The distance sensor 102 may then project the projection pattern (now denoted as 108_{B} in FIG. 1 to indicate the appearance of the projection pattern when projected from Position B) onto the target surface 106 from Position B.

The projection pattern 108_{B} is the same as the projection pattern 108_{A}, except that the appearance of the projection pattern (e.g., sizes of the points) on the target surface 106 may vary with the distance from the distance sensor 102 to the target surface 106. For instance, referring back to FIG. 2, it can be seen that as the distance increases, the points of the projection pattern (as well as the spaces between adjacent points) appear to be larger. For instance, again taking example point 110 of the projection pattern 108_{B} as an example, the spatial position of the example point 110 as calculated from an image captured by the external camera 104 from Position B may be (x_{B}, y_{B}, z_{B}). The correlation between the image position on the image sensor of the distance sensor's imaging subsystem and spatial position as calculated from the images captured by the external camera 104 from Position B may be computed and stored in a memory as calibration data.

The distance sensor 102 may be moved to a plurality of different positions (again, where the x and y coordinates of the positions are the same, and only the z coordinates differ), and the projection pattern may be projected and imaged at each of these positions, with the correlation between spatial position (as calculated from images captured by the external camera 104) and image position (as calculated from images captured by the distance sensor's imaging subsystem) at each position of the distance sensor 102 being stored as calibration data.

In the arrangement illustrated in FIG. 1, the coordinate reference (e.g., x, y, z) point of the system 100 is the same as the coordinate reference point 120 of the distance sensor 102. In one example, the mounting portion of the support 112 (i.e., the portion of the support 112 to which the distance sensor 102 is directly attached) is configured in a predetermined positional relationship with respect to this coordinate reference point 120. If the mounting portion of the support 112 is configured so that the position and direction of the mounting portion are determined based on the coordinate reference point 120 of the distance sensor 102, then the spatial position (e.g., x, y, z coordinates) of a point of the projection pattern (e.g., example point 110) will be determined correctly for all devices including the distance sensor 102 and other devices (including the external camera 104). Proper configuration of the mounting portion could be achieved using a mounting plane, reference holes, and/or a rotation stop, for example. In other words, the (x, y, z) coordinates determined by the mounting portion of the support 112 will be copied to the distance sensor 102.

Moreover, although FIG. 1 illustrates the external camera 104 as being positioned on the same side of the target object 106 as the distance sensor 102, in another example, the external camera 104 may be positioned on the opposite side of the target object 106 from the distance sensor 102. In this case, the target object 106 may comprise a transparent or translucent screen, such that the positions of points of the projection pattern on the target object 106 are still observable by the external camera 104.

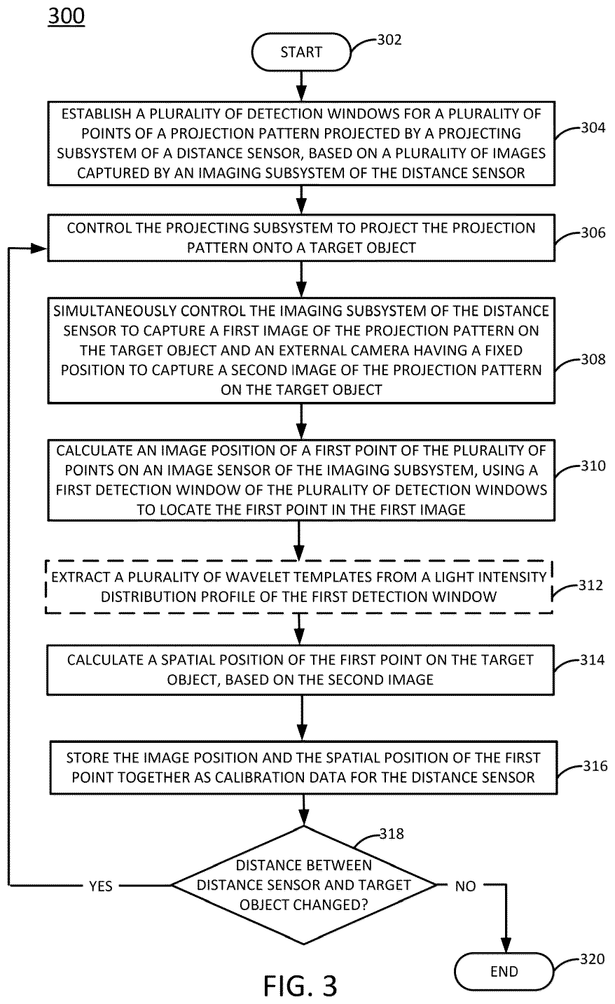

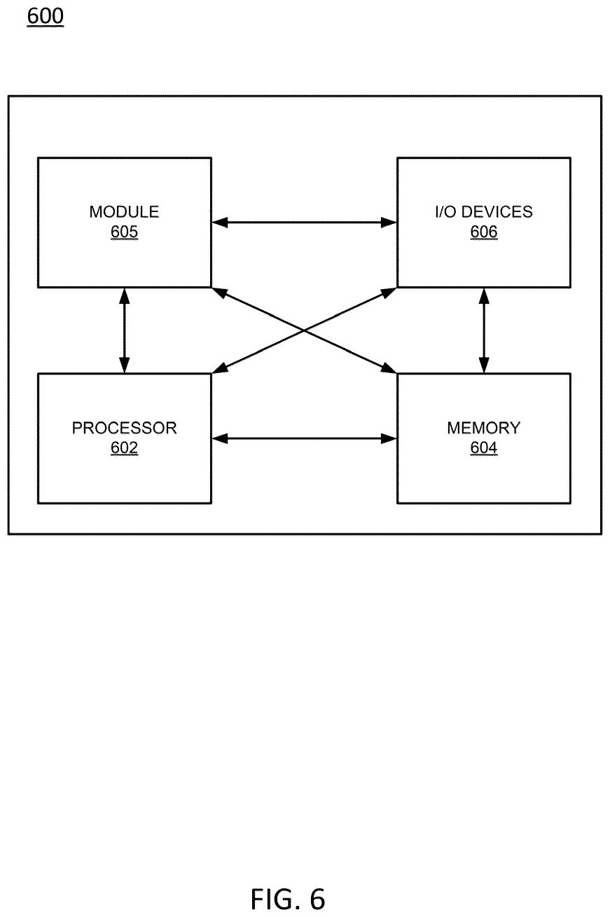

FIG. 3 is a flow diagram illustrating one example of a method 300 for calibrating a three-dimensional sensor for distance measurement, according to the present disclosure. In one example, the method 300 may be performed by the distance sensor 102 (or by a component of the distance sensor 102, such as a processor) illustrated in FIG. 1. In another example, the method 300 may be performed by a processing system, such as the processor 602 illustrated in FIG. 6 and discussed in further detail below. For the sake of example, the method 300 is described as being performed by a processing system.

The method 300 may begin in step 302. In step 304, the processing system may establish a plurality of detection windows for a plurality points of a projection pattern projected by a projecting subsystem of a distance sensor, based on a plurality of images captured by an imaging subsystem of the distance sensor.

In one example, as discussed above, the plurality of detection windows may be established by projecting the projection pattern onto a target object, such as a screen. The screen may comprise a flat, inflexible or flexible surface. A projecting subsystem of the distance sensor may create the projection pattern on the target object by projecting a plurality of beams of light in a wavelength that is invisible to the human eye (e.g., infrared). Each beam of light may create a point of light on the target object. Collectively, the plurality of points of light created by the plurality of beams may create a pattern on the target surface, i.e., the projection pattern. In one example, the projection pattern may arrange the plurality of points of light in an array (e.g., a plurality of rows and columns). For instance, the projection pattern may have an appearance similar to the projection patterns 108_{A} and 108_{B} illustrated in FIG. 2.

In one example, the imaging subsystem of the distance sensor may include a camera (hereinafter also referred to as an “internal camera”). The internal camera may include an image sensor that includes photodetectors capable of detecting one or more visible (i.e., visible to the human eye) wavelengths of light, such as red, green, and blue, as well as one or more invisible (i.e., invisible to the human eye) wavelengths of light, such as infrared.

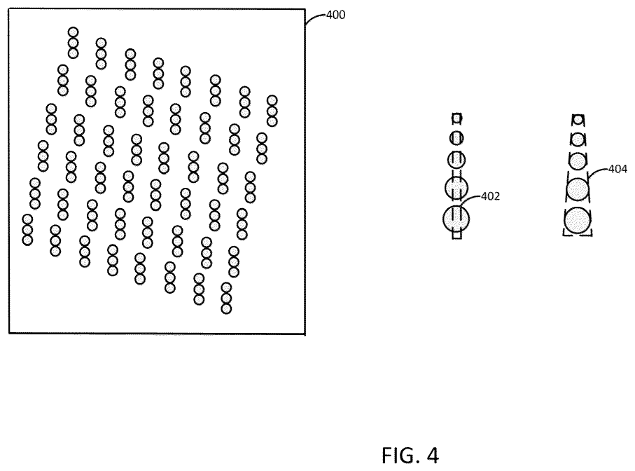

The camera of the distance sensor's imaging subsystem may capture an image of the projection pattern on the target object, and the image position of each point of the projection pattern on the image sensor of the internal camera may be calculated and recorded as discussed above. In one example, an image processing technique such as feature point detection (rather than the detection technique that will be used post-calibration to detect points of the projection pattern) is used to detect each point in each image captured by the internal camera, and the (u′, v′) coordinates of each point on the image sensor of the internal camera may then be calculated. The distance sensor may then be moved to change the distance between the distance sensor and the target object (e.g., such that the x and y coordinates of the distance sensor's position relative to the target object do not change, but the z coordinate of the distance sensor's position relative to the target object does change). As discussed above, the image position of a given point of the projection pattern on the image sensor may change as the distance between the distance sensor and the target object changes. The range in which the image position of the given point may move on the image sensor may also be referred to as the given point's “trajectory.” FIG. 4, for instance, illustrates an example of three images 400 of a projection pattern, captured at different distances from a target object, superimposed over each other to show how the image positions of the points of the projection pattern may move.

The distance between the distance sensor and the target object may be changed multiple times. Each time the distance between the distance sensor and the target object is changed, the camera of the imaging subsystem may capture images of the projection pattern, and the image position of each point of the projection pattern on the image sensor of the imaging subsystem camera may be calculated and stored. Based on the image positions of each point at multiple distances, a “detection window” may be established for each point. A detection window for a point identifies a range of positions at which the point is expected to be detected on the image sensor, based on the point's trajectory. A detection window may narrow down the positions at which the point may be expected to appear on the image sensor, regardless of the distance between the distance sensor and the target object at the time of image capture.

It should be noted that the detection window for a point does not necessarily need to match the point's trajectory exactly. In some cases, it may be possible to configure the detection window in a shape that is easy to process when performing post-calibration distance detection (e.g., a straight line, or a shape that is parallel to a pixel array of the image sensor).

Moreover, the width of the detection window need not necessarily be constant, since the size of the point will not be constant. Referring back to FIG. 4, both a constant width detection window 402 and a variable width detection window 404 are illustrated. A variable width detection window may account for the fact that a point's size as well as image position may vary with distance (e.g., the point will grow in size as the distance between the distance sensor and the target object increases). Whether the detection window is established with a constant or variable width may depend on factors such as the brightness of the point's image on the image sensor, the size of the image, the amount of light distribution in the image, the operating environment of the distance sensor, and/or other factors.

Although one example of a method for establishing detection windows is described, it will be appreciated that the detection windows may be established in other ways without departing from the scope of the present disclosure.

Moreover, the step 304 of establishing the detection windows may include steps to optimize post-calibration distance measurement (e.g., to make it easier to detect and identify points of the projection pattern during post-calibration distance measurement). In one example, these steps may include examining an image position of a point at coordinates (uₖ, vₖ), where the position of the coordinates (uₖ, vₖ) is given by a rule defined for the detection window (e.g., a predefined distance from the center, left edge, and right edge of the detection window). During post-calibration distance measurement, a given point may be searched for in an image based on the brightness and the light intensity distribution within the detection window for the given point (as discussed in further detail below), as well as the brightness and light intensity distribution on a two-dimensional plane that extends beyond the detection window by the predefined distance.

In step 306, the processing system may control the projecting subsystem to project the projection pattern onto a target object.

Once the plurality of detection windows has been established, calibration may proceed according to steps 306-314. Steps 306-314 may be performed at a plurality of different distances between the distance sensor and the target object. Thus, a first iteration of step 306 may be performed at a first distance between the distance sensor and the target object. However, step 306 (as well as subsequent steps 308-316) may later be repeated at different (e.g., second, third, fourth, etc.) distances. The number of different distances at which steps 306-316 may be repeated may depend on a desired level of accuracy (e.g., more calibration data may improve accuracy), desired processing and calibration time (e.g., it may take more time and processing to acquire more calibration data), and/or other factors. However, at each iteration of steps 306-314, the distance of the distance sensor from the target object is known.

In step 308, the processing system may simultaneously control an imaging subsystem of the distance sensor to capture a first image of the projection pattern on the target object and an external camera having a fixed position to capture a second image of the projection pattern on the target object.

In one example, the external camera, like the internal camera of the imaging subsystem, also includes an image sensor that includes photodetectors capable of detecting one or more visible (i.e., visible to the human eye) wavelengths of light, such as red, green, and blue, as well as one or more invisible (i.e., invisible to the human eye) wavelengths of light, such as infrared. However, the external camera is separate from the distance sensor (i.e., is not contained within the same housing as the distance sensor's imaging subsystem, projecting subsystem, and processor). For instance, the external camera may be mounted in a fixed position, such that the external camera's position relative to the target object does not change (while the distance sensor's position relative to the target object can be changed in the z direction).

It should be noted that the first image and the second image captured in step 308 are not part of the first plurality of images capturing in step 304 and used to establish the plurality of detection windows.

In step 310, the processing system may calculate an image position of a first point of the plurality of points on an image sensor of the imaging subsystem (of the distance sensor), using a first detection window of the plurality of detection windows to locate the first point in the first image.

In one example, the processing system may identify the first detection window in the image on the image sensor of the imaging subsystem. Then the processing system may detect the first point within the first detection window and identify the coordinates (e.g., u, v coordinates) of the first point on the image sensor. In one example, the first point may be detected by identifying the area of greatest light intensity in the first detection window. In one example, the processing system may identify the coordinates using known three-dimensional detection techniques (e.g., triangulation). For instance, the processing system may identify the coordinates of the first point on the image sensor using the techniques described in U.S. Pat. No. 11,474,245.

In optional step 312 (illustrated in phantom), the processing system may extract a plurality of wavelet templates from a light intensity distribution profile of the first detection window.

The profile or shape of the light intensity distribution waveform associated with a point of a projection pattern may vary depending upon the distance between the distance sensor and the target object upon which the distance sensor's projecting subsystem is projecting a projection pattern. However, it should be noted that other external factors (e.g., reflectance of the target object, ambient light, camera shutter speed, camera sensitivity settings, etc.) may affect the brightness of the point (and, thus, the height of the light intensity distribution waveform) and the noise in any images of the projection pattern.

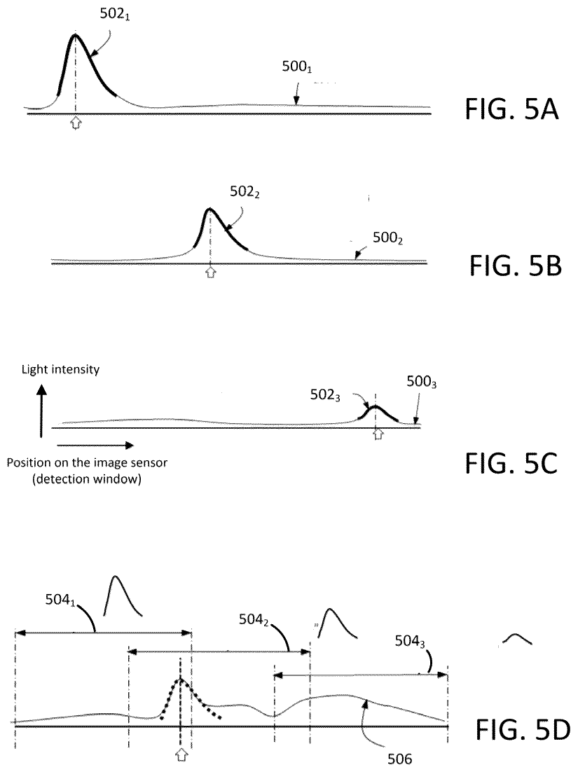

In one example, the processing system may, during the calibration process, extract a plurality of wavelet templates (also referred to as “mother wavelets” in United States Patent Application Publication No. 2007/0176759) for a point at different distances from the target object. FIGS. 5A-5C, for instance, illustrate a plurality of example light intensity distribution waveforms 500₁-500₃ (hereinafter individually referred to as a “waveform 500” or collectively referred to as “waveforms 500”) for the detection windows of the same point of a projection pattern at different distance sensor positions (i.e., different distances from a target object). Within each waveform 500, a corresponding wavelet 502₁-502₃ (hereinafter individually referred to as a “wavelet 502” or collectively referred to as “wavelets 502”) may indicate an area of peak light intensity within the detection window. As illustrated, the magnitude of the peak light intensity may be inversely proportional to the distance between the distance sensor and the target object (e.g., the smaller the distance, the greater the magnitude of the peak light intensity). In other words, the shape of the waveform 500, and of the wavelet 502, will change when the distance between the distance sensor and the target object changes.

In one example, the wavelets 502 may be extracted as wavelet templates. Each wavelet template may be associated with a detection range (a portion of the waveform for the detection window) within which the corresponding wavelet can be expected to appear, when the point position corresponds to the wavelet. The wavelet templates may then be used, during post-calibration distance measurement, to help locate a corresponding point within the corresponding point's detection window.

FIG. 5D, for instance, illustrates an example light intensity distribution waveform 506 for a detection window of a point of a projection pattern. Within the waveform 506 are a plurality of overlapping detection ranges 504₁-504₃ (hereinafter individually referred to as a “detection range 504” or collectively referred to as “detection ranges 504”), where each detection range 504 is associated with a corresponding wavelet template. If the light intensity distribution waveform 506 includes an area of peak light intensity that matches one of the wavelet templates, and if that area of peak light intensity is located within the detection range 504 that corresponds to the matching wavelet template, then the area of peak light intensity may be identified as the position of the point of the projection pattern. The dotted line in FIG. 5D shows the detected position of an example point.

Including the creation of the wavelet templates in the calibration process may enable more accurate distance detection. For instance, even if the reflectance of the target object or the exposure of the camera in the distance sensor's imaging subsystem changes during the distance measurement process, the shape of a point's waveform does not change (even though the light intensity distribution may change linearly throughout). The shape of the waveform will not change even if noise from external light is present in an image. Thus, detection of points may be possible even under conditions where detection tends to be more challenging.

In step 314, the processing system may calculate a spatial position of the first point on the target object, based on the second image.

In one example, the x and y coordinates of the spatial position may be calculated based on the position of the first point's image position in the second image (e.g., using feature point detection techniques). The z coordinate may be known from the position of the distance sensor.

In step 316, the processing system may store the image position and the spatial position together as calibration data for the distance sensor.

In one example, the spatial position (e.g., x, y, z) and image position (u, v) are stored together, i.e., in such a way as to preserve the relationship of the spatial position and the image position to the same (first) point. Thus, the data stored for the first point may comprise: (z, (x, y), (u, v)).

In a further example, the detection window for the first point may also be stored with the spatial position and image position. This will allow the detection window to be used to locate the first point during post-calibration distance measurement operations (e.g., using the techniques described in U.S. Pat. No. 11,474,245). In one example, the spatial position and image position (and detection window) may be stored in a local memory. Additionally or alternatively, the spatial position and image position (and detection window) may be stored in a remote storage location, such as a remote database.

It should be noted that steps 310-316 may be performed for more than one point of the plurality of points. For instance, image positions in the first and second images may be calculated and stored for every point of the plurality of points of the projection pattern. In another example, to save processing power and time, the image positions may be explicitly calculated for fewer than all of the plurality of points; however, points for which the image positions have not been explicitly calculated may be interpolated or extrapolated based on the image positions for the points that have been explicitly calculated.

In step 318, the processing system may determine whether the distance between the distance sensor and the target object has changed.

As discussed above, calibration of the distance sensor may involve capturing calibration data at a number of different distances, e.g., where the x and y coordinates of the distance sensor's position relative to the target object does not change, but the y coordinate does change.

For instance, in one example, the processing system may be programmed to calculate image positions of the same point(s) from multiple different distances (i.e., distances between the target object and the three-dimensional sensor system). In one example, the number and/or values of these multiple different distances may be predefined. For example the processing system may be programmed to obtain calibration data from at least n different distances. In a further example, the values of the n different distances may also be predefined (e.g., from 2 feet away, 5 feet away, 10 feet away, and so on).

If the processing system concludes in step 318 that the distance between the distance sensor and the target object has changed, then the method 300 may return to step 306 and may proceed as described above (e.g., repeating steps 306-316) to obtain calibration data at a new position.

If, however, the processing system concludes in step 318 that the distance between the distance sensor and the target object has not changed (e.g., sufficient calibration data has been gathered), then the method 300 may end in step 320.

Thus, the method 300 not only calibrates a distance sensor for distance detection, but also optimizes the distance detection process by calibrating for changes in the size, brightness, and shape of the points of the projection pattern. As discussed above, the size, brightness, and/or shape of the same point may vary depending on the distance between the distance sensor and an object onto which the distance sensor is projecting the projection pattern. These differences in size, brightness, and/or shape appear as changes in the point image on an imaging sensor, depending on the position of the image within the same trajectory. By measuring these changes in size, brightness, and shape for the points of the projection pattern, the changes can be provided as feedback for actual distance measurement by the distance sensor (i.e., post-calibration).

It should be noted that although not explicitly specified, some of the blocks, functions, or operations of the method 300 described above may include storing, displaying and/or outputting for a particular application. In other words, any data, records, fields, and/or intermediate results discussed in the method 300 can be stored, displayed, and/or outputted to another device depending on the particular application. Furthermore, blocks, functions, or operations in FIG. 3 that recite a determining operation, or involve a decision, do not imply that both branches of the determining operation are practiced. In other words, one of the branches of the determining operation may not be performed, depending on the results of the determining operation.

FIG. 6 depicts a high-level block diagram of an example electronic device for calibrating a three-dimensional distance sensor. As such, the electronic device 600 may be implemented as a processor of an electronic device or system, such as a distance sensor.

As depicted in FIG. 6, the electronic device 600 comprises a hardware processor element 602, e.g., a central processing unit (CPU), a microprocessor, or a multi-core processor, a memory 604, e.g., random access memory (RAM) and/or read only memory (ROM), a module 605 for calibrating a three-dimensional distance sensor, and various input/output devices 606, e.g., storage devices, including but not limited to, a tape drive, a floppy drive, a hard disk drive or a compact disk drive, a receiver, a transmitter, a display, an output port, an input port, and a user input device, such as a keyboard, a keypad, a mouse, a microphone, a camera, a laser light source, an LED light source, and the like.

Although one processor element is shown, it should be noted that the electronic device 600 may employ a plurality of processor elements. Furthermore, although one electronic device 600 is shown in the figure, if the method(s) as discussed above is implemented in a distributed or parallel manner for a particular illustrative example, i.e., the blocks of the above method(s) or the entire method(s) are implemented across multiple or parallel electronic devices, then the electronic device 600 of this figure is intended to represent each of those multiple electronic devices.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the blocks, functions and/or operations of the above disclosed method(s).

In one example, instructions and data for the present module or process 605 for calibrating a three-dimensional distance sensor, e.g., machine readable instructions can be loaded into memory 604 and executed by hardware processor element 602 to implement the blocks, functions or operations as discussed above in connection with the method 300. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 605 for calibrating a three-dimensional distance sensor of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or an electronic device such as a computer or a controller of a safety sensor system.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A method comprising:
establishing, by a processing system of a distance sensor, a plurality of detection windows for a plurality of points of a projection pattern projected by a projecting subsystem of the distance sensor, based on a first plurality of images captured by an imaging subsystem of the distance sensor;
controlling, by the processing system, the projecting subsystem to project the projection pattern onto a target object;
controlling, by the processing system, the imaging subsystem of the distance sensor to capture a first image of the projection pattern on the target object and an external camera having a fixed position to capture a second image of the projection pattern on the target object;
calculating, by the processing system, an image position of a first point of the plurality of points on an image sensor of the imaging subsystem, using a first detection window of the plurality of detection windows to locate the first point in the first image;
calculating, by the processing system, a spatial position of the first point on the target object, based on the second image; and
storing, by the processing system, the image position and the spatial position together as calibration data for the distance sensor.

2. The method of claim 1, wherein the establishing comprises, for each point of the plurality of points:
controlling, by the processing system, the projecting subsystem to project the projection pattern onto the target object;
controlling, by the processing system, the imaging subsystem to capture an image of the projection pattern on the target object at over a plurality of distances between the distance sensor and the target object, resulting in the first plurality of images;
detecting, by the processing system using a feature point detection technique, a position of the each point in each image of the first plurality of images;
calculating, by the processing system for each image of the first plurality of images, an image position of the each point on the image sensor of the imaging subsystem, based on the position of the each point in the each image; and
setting, by the processing system, the first detection window based on a curve that continuously connects the image position of the each point across the plurality of distances.

3. The method of claim 1, wherein a width of each detection window of the plurality of detection windows is constant.

4. The method of claim 1, wherein a width of each detection window of the plurality of detection windows varies.

5. The method of claim 1, wherein the image position according to the first image comprises a set of (u, v) coordinates, and the spatial position comprises a set of (x, y, z) coordinates.

6. The method of claim 5, wherein the set of (u, v) coordinates is obtained using a triangulation technique that is optimized during the establishing by defining a two-dimensional plane extending a predefined distance beyond the first detection window in which to inspect an image brightness and an image light intensity distribution.

7. The method of claim 6, wherein a z coordinate of the set of (x, y, z) coordinates is known from a coordinate reference point of the imaging subsystem of the distance sensor, wherein the distance sensor is mounted to a support that is movable along a track to change a distance between the distance sensor and the target object, and wherein a portion of the support to which the distance sensor is directly attached is configured in a predetermined positional relationship with respect to the coordinate reference point.

8. The method of claim 1, wherein the storing further comprises storing the first detection window with the spatial position and image position as the calibration data to facilitate post-calibration distance detection by the distance sensor.

9. The method of claim 1, wherein the controlling the projecting subsystem, the controlling the imaging subsystem and the external camera, the calculating the image position of the first point, the calculating the spatial position of the first point, and the storing the image position and the spatial position are repeated for a plurality of different distances between the target object and the distance sensor.

10. The method of claim 9, wherein x and y coordinates of a position of the distance sensor remain constant over all distances of the plurality of different distances, and only a z coordinate of the position of the distance sensor changes over the all distances.

11. The method of claim 10, wherein the controlling the projecting subsystem, the controlling the imaging subsystem and the external camera, the calculating the image position, the calculating the spatial position, the storing the image position and the spatial position, and the repeating are performed for all points of the plurality of points.

12. The method of claim 1, further comprising:
extracting, by the processing system, a plurality of wavelet templates from a light intensity distribution profile of the first detection window, wherein the plurality of wavelet templates is stored to facilitate post-calibration distance detection by the distance sensor.

13. The method of claim 12, wherein each wavelet template of the plurality of wavelet templates indicates an area of peak light intensity within the first detection window for a different image of a second plurality of images.

14. The method of claim 13, wherein the area of peak light intensity corresponds to an image position of the first point for one image of the second plurality of images.

15. The method of claim 14, wherein each wavelet template of the plurality of wavelet templates is associated with a detection range within which the corresponding wavelet template can be expected to appear, when the image position of the first point in the one image corresponds to the wavelet template.

16. The method of claim 13, wherein each wavelet template of the plurality of wavelet templates has a different shape, and the different shape is dependent upon a distance between the distance sensor and the target object at a time at which an image of the second plurality of images from which the each wavelet template is extracted was captured.

17. The method of claim 1, wherein the external camera comprises a camera that is separate from a housing of the distance sensor that contains the projecting subsystem, the imaging subsystem, and the processing system.

18. The method of claim 1, wherein the target object comprises a flat screen having a uniform color and uniform reflectance.

19. A non-transitory machine-readable storage medium encoded with instructions executable by a processor of a distance sensor, wherein, when executed, the instructions cause the processor to perform operations, the operations comprising:
establishing a plurality of detection windows for a plurality of points of a projection pattern projected by a projecting subsystem of the distance sensor, based on a plurality of images captured by an imaging subsystem of the distance sensor;
controlling the projecting subsystem to project the projection pattern onto a target object;
controlling the imaging subsystem of the distance sensor to capture a first image of the projection pattern on the target object and an external camera having a fixed position to capture a second image of the projection pattern on the target object;
calculating an image position of a first point of the plurality of points on an image sensor of the imaging subsystem, using a first detection window of the plurality of detection windows to locate the first point in the first image;
calculating a spatial position of the first point on the target object, based on the second image; and
storing the image position and the spatial position together as calibration data for the distance sensor.

20. An apparatus comprising:
a processing system including at least one processor; and
a non-transitory machine-readable storage medium encoded with instructions executable by the processing system, wherein, when executed, the instructions cause the processing system to perform operations, the operations comprising:
establishing a plurality of detection windows for a plurality of points of a projection pattern projected by a projecting subsystem of the distance sensor, based on a plurality of images captured by an imaging subsystem of the distance sensor;
controlling the projecting subsystem to project the projection pattern onto a target object;
controlling the imaging subsystem of the distance sensor to capture a first image of the projection pattern on the target object and an external camera having a fixed position to capture a second image of the projection pattern on the target object;
calculating an image position of a first point of the plurality of points on an image sensor of the imaging subsystem, using a first detection window of the plurality of detection windows to locate the first point in the first image;
calculating a spatial position of the first point on the target object, based on the second image; and
storing the image position and the spatial position together as calibration data for the distance sensor.
